(19) United States
(12) Patent Application Publication
(10) Pub. No.: US 2010/0102700 A1
(43) Pub. Date: Apr. 29, 2010

(54) Flame spray pyrolysis with versatile precursors for metal oxide nanoparticle synthesis and applications of submicron inorganic oxide compositions for transparent electrodes

(76) Inventors: Abhishek Jaiswal, Fremont, CA (US); Frank O. Ernst, Zurich (CH); Shivkumar Chiruvolu, San Jose, CA (US); Jia X. Lee, Singapore (SG); Robert Buchel, Zurich (CH); Sotiris E. Pratsinis, Zurich (CH)

Correspondence Address: DARDI & HERBERT, PLLC, 220 S. 6TH ST., SUITE 2000, U.S. BANK PLAZA, MINNEAPOLIS, MN, 55402, US

(21) Appl. No.: 12/288,890

(22) Filed: Oct. 24, 2008

(51) Int. Cl. H01J 1/00; C01G 41/02; B01J 19/00

(52) U.S. Cl. 313/311; 423/606; 422/187

(57) ABSTRACT

Flame spray pyrolysis can be performed using aqueous solvents for the delivery of metal and/or metalloid oxide precursors while obtaining desirably high flame temperatures for the synthesis of uniform submicron inorganic oxide particles. A multiple liquid channel nozzle can be used to deliver liquid for the formation of the aerosol that is combusted in the flame. One or both channels can deliver liquid with metal/metalloid precursors and/or organic fuels. Flame spray pyrolysis can be used to form metal tungsten oxide submicron particles. Metal tungsten oxide compositions can be used in the formation of transparent electrodes. If the transparent electrodes are formed from polymer inorganic particle composites, the composites can further comprise electrically conductive nanoparticles to improve the electrical conductivity.

### FIELD OF THE INVENTION

The invention relates to flame spray pyrolysis with versatile precursor fuel configurations that provide for a broader range of fuel selection especially for the formation of particles with a plurality of metals. The invention further relates to transparent electrodes formed from tungsten bronze compositions and/or other electrically conductive compositions.

### BACKGROUND OF THE INVENTION

Advances in a variety of fields have created a demand for many types of new materials. In particular, a variety of chemical powders can be used in many different processing contexts, such as the production of electrical components, optical components, electro-optical components and batteries. Similarly, technological advances have increased the demand for improved material processing with strict tolerances on processing parameters. As miniaturization continues even further, material parameters will need to fall within stricter tolerances. Current integrated circuit technology already requires tolerances on processing dimensions on a submicron scale. The consolidation or integration of mechanical, electrical and optical components into integral devices has created further demands on material processing.

Flame pyrolysis has been used commercially to make fumed silica, fumed titania and some other metal oxides. Thus, flame pyrolysis is one approach for the commercial production of fine metal oxide particles. To drive the flame in these systems, oxygen, e.g., air, is generally present to support the burning of the fuel to sustain the flame.

### SUMMARY OF THE INVENTION

In a first aspect, the invention pertains to a display device comprising an electronic circuit having a transparent electrode, the transparent electrode comprising MₓW_{y}O_{z}, where M is a metal element or a combination thereof and x/y is greater than zero and no more than 0.99 and where z/y is at least 2.0 and no more than 3.0.

In a further aspect, the invention pertains to a composite comprising a polymer binder, inorganic oxide particles and supplemental electrically conductive particles. The inorganic oxide particles generally have an average primary particle size of no more than about 250 nm. The supplemental electrically conductive particles can comprise electrically conductive carbon particles, elemental metal particles, metal alloy particles or mixtures thereof The supplemental electrically conductive particles can have an average primary particle size of no more than about 100 nm. In some embodiments, the inorganic oxide particles can comprise indium tin oxide, antimony tin oxide, MₓW_{y}O_{z}, where M is a non-tungsten metal element or a combination thereof and x/y is greater than zero and no more than 0.99 and where z/y is at least 2.0 and no more than 3.0, or combinations thereof.

In additional embodiments, the invention pertains to a method for synthesizing metal/metalloid oxide particles. The method comprises pyrolyzing in a flame a precursor composition comprising a water soluble metal composition, an organic liquid and at least about 2 weight percent water. The water and organic liquid are blended within a un-phase separated blended liquid.

In other embodiments, the invention pertains to a method for the synthesis of metal/metalloid oxide particles, in which the method comprises the step of pyrolizing in a flame an aerosol of a first precursor composition that is delivered into the flame through a first channel of a multiple channel concentric nozzle. A fuel, a second precursor composition or a combination thereof are delivered through a second channel of the nozzle.

Furthermore, the invention pertains to a flame spray pyrolysis apparatus comprising a reaction chamber, a nozzle configured to deliver an aerosol within the reaction chamber, a particle collection system and a precursor delivery system, the reaction chamber comprising walls to at least partially enclose a flame and a flame ignition tool, the particle collection system configured to collect particles produced in the flame, the nozzle having a plurality of liquid delivery channels and the precursor delivery system operably connected to the nozzle deliver a plurality of liquids to distinct channels of the nozzle and a gas to impact on the liquid to form an aerosol.

### BRIEF DESCRIPTION OF THE DRAWINGS

FIG. 1 is a schematic sectional view of a flame spray pyrolysis apparatus.

FIG. 2 is a schematic sectional view of a particular embodiment of a flame spray pyrolysis apparatus having a single inlet nozzle.

FIG. 3 is a schematic sectional view of the flame spray pyrolysis apparatus of FIG. 2 adapted with a dual inlet concentric nozzle.

FIG. 4 is an expanded view of the nozzle of FIG. 3.

FIG. 5 is a schematic perspective view of a device with a transparent electrode.

FIG. 6 is a schematic front view of a device with a transparent electrode forming a grid.

FIG. 7 is a transmission electron micrograph of the heat treated powder from Example 1.

FIG. 8 is a plot of transmission spectra of a 0.01 wt % dispersion of the heat treated powders from Examples 1-5 in water. (a) is wavelength vs. % of transmission; (b) is wavelength vs. absorption.

FIG. 9 is a transmission electron micrograph of the heat treated powder from Example 3.

FIG. 10 is a transmission electron micrograph of the powder with x=0.3 heat treated at 550° C. from Example 5.

FIG. 11 is plot of transmission spectra of a 0.01 wt % dispersion of the powders with x=0. 1, 0.2, 0.3, 0.4, heat treated at 600° C. from Example 5 in water. (a) is wavelength vs. % of transmission; (b) is wavelength vs. absorption.

FIG. 12 is a plot of an optical transmission spectrum of polymer coated cesium tungsten oxide nanoparticles.

FIG. 13 is a graph of normalized resistance as function of percentage volume of nanoparticles of cesium tungsten oxide, tin oxide or antimony tin oxide.

### DETAILED DESCRIPTION OF THE INVENTION

Flame spray pyrolysis has been adapted with highly flexible precursor delivery systems that allow for the use of less expensive precursor compositions as well as for the selection of precursors that are suitable for the formation of a wide range of mixed metal oxide particles. Specifically, in some embodiments, aqueous solutions have been developed as precursor solutions that can sustain a flame at a sufficient temperature for the production of highly dispersible and uniform submicron metal oxide particles. Also, the use of a multiple inlet, e.g. co-axial, nozzle has been demonstrated to provide additional flexibility for the delivery and successful particle production for multiple precursors involving multiple metal elements. In particular, metal tungsten oxide nanoparticles with high uniformity and a submicron average particle size have been produced. It has been determined that appropriately designed tungsten bronzes can be used to form transparent electrodes. For example, the transparent electrodes can be formed with a film of tungsten bronze composition or with a polymer composite of the tungsten bronze particles or with a film.

In general, flow based methods have been found to be versatile approaches for the formation of submicron inorganic particles. For example, laser pyrolysis can be used for the synthesis of a range of mixed metal oxide particles as described in U.S. Pat. No. 6,607,706 to Kumar et al., entitled “Composite Metal Oxide Particles,” incorporated herein by reference. Spray flame pyrolysis provides an alternative flow approach for the synthesis of mixed metal oxide particles with high particle quality in commercial quantities. Some specific precursor formulations for flame spray pyrolysis are described in U.S. Pat. No. 5,958,361 to Laine et al, entitled “Ultrafine Metal Oxide Powders by Flame Spray Pyrolysis,” and U.S. Pat. No. 7,211,236 to Stark et al., entitled “Flame Made Metal Oxides,” both of which are incorporated herein by reference.

With respect to the improved precursor systems described herein, it was discovered that aqueous solvents can be used to supply metal precursor compositions. With aqueous precursor solutions, the water removes heat from the flame through evaporation and heating of the water without supplying any heat through combustion. Thus, sufficient fuel should be supplied to maintain desired flame temperatures in view of the aqueous solvent. In some embodiments, the precursors further comprise an organic solvent that is soluble in the water or dissolves the water, and the water and organic liquid(s) may or may not be miscible. The organic liquid can provide at least some of the fuel for the flame pyrolysis. Calculations can be performed to estimate the flame temperature for certain solvent combinations with a selected percentage of the solvent comprising the fuel.

Aqueous solvent mixtures can take advantage of solubility properties of various liquid components to form a precursor solution with a range of precursor compositions due to the solubility contributions of the water as one of the liquids. For example, selected alcohols and acetone are miscible with water as well as organic solvents so that combined systems can incorporate complex blends of liquids that do not phase separate. With respect to selected organic liquid components, diethylene glycol monobutyl ether is a high energy organic liquid that is miscible in both water and many organic solvents. Other suitable organic liquid components include, for example, 2-ethyl hexanoic acid, ethanol amine and ethylene glycol. Thus, the organic liquid components of the aqueous precursor solutions can contribute as a significant fuel for the flame. Alternatively or additionally, an organic liquid fuel can be delivered through a separate channel of a multi-channel nozzle to supply the desired amount of heat generation for the flame. In summary, the use of aqueous chemistry provides production economic advantages such as the ability to use precursor solutions with greater molar concentrations and the ability to avoid expensive metallo-organic precursors.

In contrast with the aqueous solutions described herein, aqueous emulsions have been described for flame pyrolysis. For example, the preparation of emulsions that are sprayed into a flame at relatively low temperatures of 700° C. to 1000° C. is described in U.S. Pat. No. 5,811,068 to Takatori et al., entitled “Method of Producing Oxide Powder,” incorporated herein by reference. Similarly, a similar approach for the use of fuel and water emulsions are described in U.S. Pat. No. 5,984,997 to Bickmore et al., entitled “Combustion of Emulsions: A method and Process for Producing Fine Powders,” incorporated herein by reference. The aqueous solutions described herein are significantly more versatile precursor systems while achieving desirable product properties.

The use of an aqueous solvent greatly increases the flexibility for the selection of metal precursor compositions that are incorporated into the precursor solutions. A blend of metal compositions can be introduced into the aqueous solvent so that a plurality of metal elements can be delivered in the common solution with the aqueous solvent system, generally without difficulty in selecting a suitable metal composition that is readily available at a reasonable cost. In addition, less expensive metal compositions can be used, so that the processes are more commercially viable.

In additional or alternative embodiments, the precursors solutions can be delivered into the flame with a multiple-inlet nozzle. In some embodiments, the inlets are co-axial, and nozzles with cylindrical symmetry, the multiple inlet nozzle can be concentric. Use of concentric burners for particle synthesis have involved vapor phase reactants, as described in U.S. Pat. No. 5,498,446 to Axelbaum et al., entitled “Method and Apparatus for Producing High Purity and Unagglomerated Submicron Particles,” and U.S. Pat. No. 5,861,132 to Pratsinis et al., entitled “Vapor Phase Flame Process for Making Ceramic Particles Using a Corona Discharge Electric Field,” both of which are incorporated herein by reference. Multiple reactant inlets have been described for laser pyrolysis in published U.S. patent application 2002-0075126A to Reitz et al., entitled “Multiple Reactant Nozzles for a Flowing Reactor,” incorporated herein by reference.

The use of a multiple inlet nozzle with flame spray pyrolysis invokes significantly different considerations from either laser pyrolysis or vapor-based flame pyrolysis. In particular, laser pyrolysis involves a light source that supplies a significant amount of the energy for the reaction, and the reactive flow may or may not receive large amounts of heat from the reaction itself. In comparing the vapor-base flame pyrolysis with the spray approach for flame pyrolysis, the spray approach has significantly different mixing parameters relative to the vapor delivery. Nevertheless, it has been discovered that crystalline multiple metal oxide particles surprisingly can be formed with different precursors being delivered through different channels of the multiple channel nozzle. Similarly, if fuel is delivered through one channel and a precursor delivered through another channel, good quality, visibly non-porous submicron particles can be formed.

A flame spray pyrolysis reactor generally comprises a reaction chamber, a precursor delivery system and a collection system. In some embodiments, the reaction chamber can be open to the ambient environment, and air can be drawn into the reaction chamber from the surroundings to supply additional oxygen to the flame and/or to contribute to quenching of the product metal oxide particles as they leave the flame. The precursor delivery system generates an aerosol at a nozzle, and the aerosol provides both the fuel that feeds the flame and the precursor compositions that react to form the product particles. A reasonable particle collector can be attached to the system. For example, for embodiments in which the system is open to the atmosphere, a conventional bag collector can be attached to the system or the flow can be directed through a filter element with a pump, blower or the like maintaining the desired flow pattern.

In flame spray pyrolysis, an aerosol can be produced within the reaction chamber using a suitable aerosol generator integrated with the nozzle. The aerosol droplets are then ignited in the flame. In particular, oxygen gas, for example, in relatively pure form or as air, can be delivered to impinge on the liquid precursor flow to form the aerosol and to provide an oxidizing agent for the flame. Alternatively, other aerosol generation techniques can be used to generate the aerosol from the liquid precursor. In some embodiments, the nozzle can comprise a central channel for liquid precursor delivery. In further embodiments, the nozzle can comprise a plurality of channels for liquid precursor and/or fuel delivery. In some embodiments, the gas flow impinges on the multiple liquid flows emerging from the nozzle to disperse the liquid flow into aerosol droplets. Different channels of the nozzle can carry distinct liquids. It has been discovered surprisingly that the distinct liquid are combined within the flame with this delivery approach such that multiple metal oxide particles, including crystalline multiple metal oxide particles, can be synthesized with good compositional uniformity. The ability to use a multiple channel nozzle greatly expands the flexibility for precursor selection for flame spray pyrolysis.

In flame spray pyrolysis, the metal compositions are generally dissolved in a solution that comprises an organic fuel for supporting the flame. The fuels can be selected to contribute heat of combustion so that desired flame temperatures can be achieved. For the production of uniform submicron particles, it has been found that high flame temperatures generally are desired, such as at least than 1500° C. in some embodiments. Thus, the liquid selection and metal composition selection can be coordinated such that the metal composition is soluble in the liquid and the liquid supplies a desired amount of enthalpy from combustion of the fuel to drive the reaction to form metal oxide submicron particles. However, this heat target imposes significant restraints on selection of the liquid fuel and correspondingly on metal composition, which are soluble in the liquid. This complexity with respect to selection of the fuel and precursor composition can be even more acute if it is desired to introduce a plurality of metal elements into the flow.

In general, water does not contribute at all to the heat of reaction, and water actually removes heat from the flame through evaporation and heating. However, it has been discovered that suitable aqueous solutions can be used to deliver metal precursors into a flame spray pyrolysis reactor while achieving desired submicron metal oxide particles. Suitable organic liquids as fuel can be combined with the water or delivered separately in other channels of a multiple channel nozzle. Blends of organic liquids can be used to adjust viscosity while delivering desired amounts of enthalpy to the flame. For example, alcohols can be used to lower the viscosity.

The flame spray pyrolysis techniques described herein are well suited for the synthesis of particles with multiple metal and/or metalloid elements. For example, compositions with the formula MₓW_{y}O_{z} can be synthesized, where x/y is at least 0.01 and no more than 0.99, and where z/y is at least 2.0 and no more than 3.0. These tungsten compositions have been referred to as tungsten bronzes. In some embodiments, the tungsten bronze compositions of interest have a formula MₓWO₃, where M is a non-tungsten metal such as an alkali metal, and 0<x<1. Tungsten bronze compositions have been recognized for their ability to absorb infrared light from solar radiation. This is described, for example in U.S. Pat. No. 3,505,108 to Mochel, entitled “Tungsten Bronze Films,” incorporated herein by reference. As described in the examples below, tungsten bronze submicron particles have been synthesized using flame spray pyrolysis using the improved precursor systems described herein.

The introduction of the aliovalent metal, i.e., metal cations with a different oxidation state from the host cations, along with oxygen non-stoichiometry introduces electronic defects into the tungsten oxide material and results in the infrared radiation absorption property noted above. The electronic defects also result in electrical conductivity of the material. However, as more non-tungsten metal is introduced into the tungsten oxide resulting in greater oxygen non-stoichiometry, then the tungsten oxide material becomes more absorbing in the visible portion of the spectrum. It has been discovered that if the various parameters of the system are balanced, the tungsten bronze materials are suitable for the formation of transparent electrodes, which can be substituted or combined with other materials for transparent electrodes, such as electrically conductive nanoparticles or indium tin oxide (ITO, or tin-doped indium oxide) and antimony-doped tin oxide (ATO).

The tungsten bronze particles can be formed into thin films to form transparent electrodes. This can be done by depositing a coating from a particulate dispersion using, for example, painting, spraying, printing, dip coating, extruding, casting, or the like, and followed by a post-heat treatment for densification. Also, physical vapor deposition and/or chemical vapor deposition (PVD/CVD), sputtering, or sol-gel processes can be used to deposit tungsten bronze films. The melting point of Cs_{0.3}WO₃ submicron particles have been measured to be about 1010° C., which is significantly lower than the melting point of indium tin oxide (ITO), which is about 1900° C. Therefore, tungsten bronzes have a lower densification temperature than ITO materials. This provides for the ability to use a wider variety of substrates for thin film deposition, such as high melting temperature substrates, such as some glasses, to substrates that cannot tolerate very high temperatures. Additionally, tungsten bronze targets for sputtering equipment can be fabricated using tungsten bronze particles pressed or deposited and sintered at appropriate fusing temperatures.

In further embodiments, the tungsten bronze particles can be incorporated into polymer composites at relatively high loadings. The composites can be formed into films that can be used as transparent electrodes. Optionally, additional electrically conductive nanopowders, such as metal particles or carbon black, can be introduced in moderate amounts to increase the electrical conductivity without excessively diminishing the transmission of visible light. Flame spray pyrolysis can similarly be used to produce indium tin oxide and antimony tin oxide particles for use in transparent electrodes.

The improved precursor delivery systems provide for improved ability to select precursors for flame spray pyrolysis through the use of aqueous solvents and/or through the use of multiple inlet nozzles. The improved precursor systems provide for commercial synthesis of a broader range of materials through the ability to use less expensive precursor compositions as well as providing for combinations of metal elements that may be difficult or impossible to deliver practically without these improved precursor options. Practical synthesis approaches are described in the examples for the synthesis of tungsten bronzes. It has been found that tungsten bronzes are suitable for the formation of transparent electrodes in several formats. These materials provide alternatives or complementary materials relative to other transparent conductive material, such as ITO and ATO.

### Flame Spray Pyrolysis Apparatus

A flame spray pyrolysis apparatus comprises a reaction chamber, a precursor delivery system and a collection system. The reaction chamber at least partially encloses a flame that involves the combustion of a fuel. The heat generated by the combustion of the fuel drives the reaction of the precursor composition(s) to form metal oxide particles. The reaction chamber generally also comprises an ignition source to light the main, i.e., particle production, flame. The precursor delivery system interfaces with the reaction chamber at a nozzle that generates an aerosol of the precursor within the reaction chamber. In some embodiments, the nozzle can comprise multiple inlets that provide for the delivery of multiple liquids into the aerosol stream feeding the main flame. The aerosol generator can be designed to generate the aerosol flow based on the combined liquid of the flow from the two nozzle inlets.

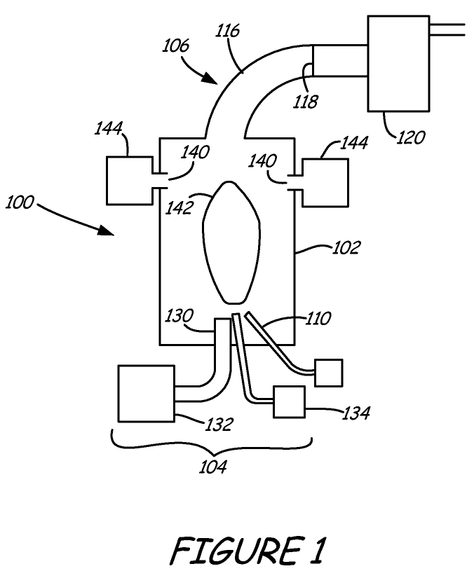

Referring to FIG. 1, an embodiment of a flame spray pyrolysis apparatus is shown schematically. Apparatus 100 comprises a reaction chamber 102, precursor delivery system 104 and collection/exhaust system 106. Reaction chamber 102 generally comprises an ignition source 110, which can be a gas torch, an electric arc, a laser beam or the like. In general, a gas torch can provide a stable flame for particle production, and a suitable gas torch can comprise a multi-channel metal/ceramic element fed with oxygen or air in one channel and a flammable gas, such as hydrogen, methane or natural gas, in another channel.

The flame within the reaction chamber can be oriented in a selected direction, which generally can be any direction, such as upward, downward or horizontal, that provides for appropriate interface with the collection system. Reaction chamber 102 may only vent into the collection system, or reaction chamber 102 may also have an opening to the ambient atmosphere to draw air into the chamber. As shown in FIG. 1, reaction chamber 102 only opens into the collection system. Reaction chamber 102 can be formed from appropriate heat resistant materials such as ceramics, for example, alumina, glass, quartz or the like, or appropriate metals, and the reaction chamber components or portions thereof may be externally cooled.

Collection system 106 comprises conduits 116, a collection device 118 and an optional flow device 120. Conduits 116 direct the flow from the reaction chamber to collection device 118 as well as connecting other portions of the collection system. Collection device 118 can be a filter, a bag house-style collector or other suitable particle collection device. Optional flow device 120 can be a blower, a pump or the like. In some embodiments, the expansion of the flame front may maintain flow through the system without a flow device, especially if the reaction chamber is not open to the ambient air. The particular selection of the collection device may also influence the desire to have a flow device. Optional scrubbers, traps and/or the like can be used to meet environmental regulation or to recover materials from the flow prior to venting.

Precursor delivery system 104 comprises a nozzle 130, a liquid supply system 132 and a gas supply system 134. Nozzle 130 generally forms an aerosol of precursor liquid within the reaction chamber. In general, nozzle 130 can integrate any suitable aerosol generator within its design to generate the aerosol. However, since the feed to the flame involves a gaseous oxidizing agent and a liquid fuel along with the liquid precursor, it can be convenient to use a gas impingement aerosol generator or variations thereof, in which the liquid comprising a fuel and precursor composition(s) is fractured into the aerosol through interaction with the gas flow. Nozzle 130 generally is formed from one or more materials, in which at least one material can tolerate high flame temperatures, and similar ceramic and/or metal materials can be used which can be used for the reaction chamber. For example, high shear Bernoulli aerosol generators are described with high velocity oxygen gas as the atomizing gas for use in a flame spray pyrolysis apparatus in U.S. Pat. No. 5,958,361 to Laine et al., entitled “Ultrafine Metal Oxide Powders by Flame Spray Pyrolysis,” incorporated herein by reference. Another particular design is described further in the following discussion.

Liquid supply system 132 provides the liquid precursors and generally liquid fuel to nozzle 130 from a reservoir or the like. Liquid supply system 132 can comprise a pump or the like, such as a syringe pump, a centrifugal pump, a peristaltic pump or other convenient pump, to maintain the flow from a reservoir to the nozzle. In some embodiments with a multiple inlet nozzle, liquid supply system comprises a plurality of reservoirs as well as optionally pumps and corresponding tubing and the like to supply separate liquids to the nozzle. Gas supply system 134 can supply oxygen, air or other gaseous oxidizing agent to nozzle 130 to react with the fuel in the flame.

Windows 140 provides for visualization of flame 142. A spectroscopic measuring apparatus 144 can be used to evaluate the flame temperature optically through windows 140. For example, Fourier transform infrared emission/transmission spectroscopy has been used to measure average flame temperature, and windows can be selected to be infrared transmitting to provide for the measurements. The evaluation of the average flame temperature from the infrared measurements is described further in Arabi-Katbi et al., “Monitoring the flame synthesis of TiO₂ particles by in situ FT-IR spectroscopy and thermophoretic sampling,” Combustion and Flame, 124(4): 560-572 (2001) and Morrison et al., “In situ Fourier transform infrared characterization of the effect of electrical fields on the flame synthesis of TiO₂ particles,” Chemical Matter, 9(12): 2702-2708 (1997), both of which are incorporated herein by reference.

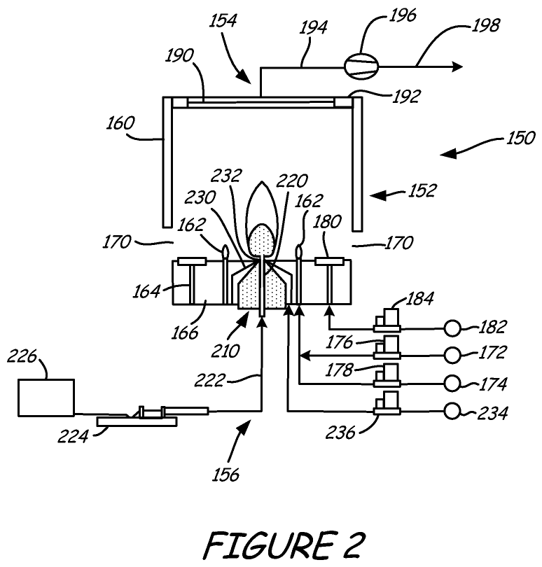

A specific embodiment of a flame spray pyrolysis apparatus is shown schematically in a sectional view in FIG. 2. Apparatus 150 comprises reaction chamber 152, collection system 154 and precursor delivery system 156. Reaction chamber 152 comprises a housing 160, gas-driven flame-lets 162, a shielding gas port 164 and chamber base 166 that support portions of flame-lets 162 and shielding gas ports 164. Housing 160 generally is formed of a high temperature material to tolerate the flame temperatures. Housing 160 has air vents 170 that provide for drawing air from the surroundings into the chamber during operation.

Chamber 152 has cylindrical symmetry from above and, in one embodiment, has six flame-lets 162 around the circumference. Flame-lets 162 can comprise a ceramic torch with separate oxygen and fuel channels. Flame-lets 162 are operably connected to gas fuel source 172, which can supply methane or other selected gaseous fuel, and oxygen source 174. Flow from gas fuel source 172 and oxygen source 174 can be controlled with mass flow controllers 176, 178, respectively. Flame-lets 162 can be lit before the start of particle production runs and kept lit to ignite the particle production flame when the nozzle is delivering precursor. In alternative or additional embodiments, the flame-lets may be turned off at some point in the process, or alternative ignition sources can be used. Shielding gas port 164 can comprise an annular opening 180 and can be used to deliver oxidizing gas, such as air or oxygen, and/or inert gas, such as nitrogen or argon, from gas supply 182 with flow controlled by mass flow controller 184. Flow of shielding gas from gas port 164 can constrain the flame, can provide additional oxygen for the combustion reaction and can provide more consistent reaction conditions within the chamber.

Collection system 154 interfaces with the top of housing 160 in the configuration of FIG. 2. Collection system 154 comprises a filter 190 supported by filter holder 192. Conduit 194 connects filter 190 with pump 196 which has a vent 198.

Precursor delivery system 156 comprises nozzle 210, precursor supply system 212 and gas supply system 214. Nozzle 210 is interfaced with housing base 166. Nozzle 210 comprises a capillary 220 that is connected to tubing 222. Tubing 222 transports liquid from syringe pump 224 to capillary 220. Syringe pump 224 pumps liquid from precursor reservoir 226. Reservoir 226 generally holds a liquid that comprises an organic fuel as well as dissolved metal precursor(s). Syringe pump 224 can be replaced with other suitable pumps or combinations of pumps. An annular gas flow channel 230 directs gas to a gap 232 adjacent the tip of capillary 220 such that the impact of the gas disrupts the liquid flow and forms the aerosol form the liquid flow. Oxygen gas or air can be directed to channel 230 from supply 234 with flow controlled by mass flow controller 236. A similar precursor delivery system is described further in an article by Madler et al., entitled “Controlled Synthesis of Nanostructured Particles by Flame Spray Pyrolysis,” Aerosol Science 33(2002) 369-389.

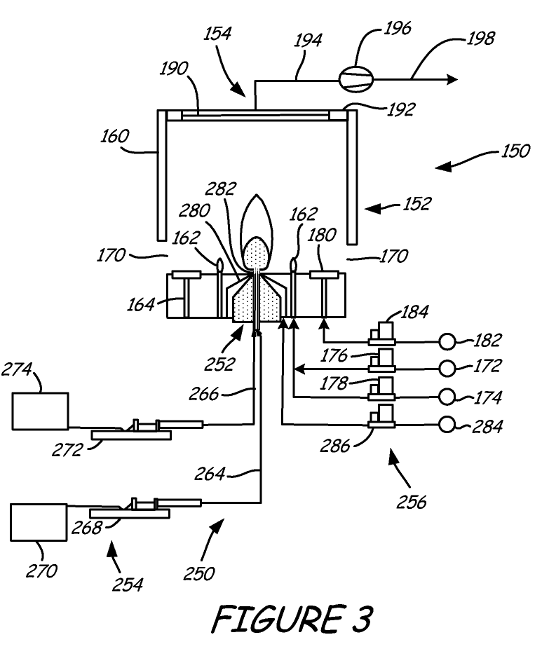

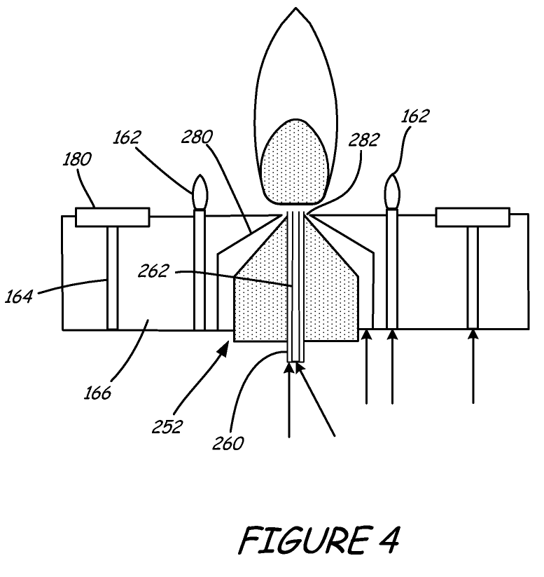

Flame spray pyrolysis apparatus 150 with an alternative precursor delivery system/nozzle is shown in FIG. 3, and an expanded view of the chamber base 166 with the alternative precursor delivery system is shown in FIG. 4. Referring to FIGS. 3 and 4, precursor delivery system 250 comprises nozzle 252, precursor supply system 254 and gas supply system 256. Nozzle 252 again is interfaced with housing base 166. Nozzle 252 comprises two nested concentric capillaries 260, 262 with capillary 262 within capillary 260, as shown in FIG. 4.

Referring to FIG. 3, liquid from tubing 264 flows into capillary 262, and liquid from tubing 266 flows into the channel between capillaries 260 and 262. Syringe pump 268 supplies tube 264 with liquid from reservoir 270, and syringe pump 272 supplies tube 266 with liquid from reservoir 274. At least one of reservoirs 270, 274 should hold liquid organic fuel, and at least one of reservoirs 270, 274 should hold a liquid with dissolved metal precursors. An annular gas flow channel 280 directs impinging gas to a gap 282 adjacent the tip of capillaries 260, 262 such that the impact of the gas disrupts the liquid flow from both of the capillaries forms a combined aerosol from the liquid flow. Oxygen gas or air can be directed to channel 280 from supply 284 with flow controlled by mass flow controller 286.

It has been found that the size and quality of the particle obtained from the flame spray pyrolysis apparatus is influenced by the flame temperature. In particular, it is desirable for the flame temperature to be hot to form small and higher quality particles. Thus, it is desirable for the average flame temperature to be at least about 1500° C., in further embodiments at least about 1700° C., in additional embodiments at least about 1800° C. and in other embodiments from about 1900° C. to about 3000° C. A person of ordinary skill in the art will recognize that additional ranges of temperature within the explicit ranges above are contemplated and are within the present disclosure.

While the nozzle in FIGS. 3 and 4 is a concentric cylindrical nozzle other multiple inlet nozzle designs can be used effectively based on the present disclosure. In particular, co-axial inlets with a non-circular shape of the nozzle can be used. Other shapes include, for example, oval, square or the like, although circular can be convenient for stable flame properties. In addition, multiple inlets may not be co-axial. For example, two or more adjacent or bundled capillaries with a surrounding impinging gas flow can be used to deliver the aerosol from multiple inlets.

### Flame Spray Pyrolysis Precursors and Liquid Fuels

To sustain the particle production flame in the flame spray pyrolysis apparatus, an aerosol comprising liquid fuel and metal precursors are fed into the flame. It has been found that aqueous liquids can be used to supply the precursor while still maintaining a sufficiently hot flame to form submicron metal oxide particles. Furthermore, a multiple inlet nozzle can be used as described above. The use of such a nozzle provides considerable flexibility with respect to separate delivery of all or a portion of the fuel from the metal precursor and/or separately delivering different metal precursors from each other for the formation of mixed metal oxides. The design of the precursor/fuel system can be facilitated through the calculation of the heat contribution of particular fuel choices which can be taken into account along with the solubilities of the fuel and precursor compositions.

The metal precursors are metal compositions that provide the metal elements for the formation of the metal oxide particles. The metal precursor compositions generally can be dissolved into an appropriate solvent for delivery of the metal precursor. For the formation of mixed metal oxide particle, a plurality of metal elements is provided by one or more metal precursors. In general, any metal element or combination of metal elements associated with a reasonable precursor composition can be introduced into the flame for the synthesis of desired metal oxide particles. With the ability of using aqueous solutions for the delivery of the metal precursor compositions, the precursor systems described herein have an expanded number of suitable metal compositions, such as metal salts and the like, for delivery into the flame. The concentration of the metal precursor composition and the amount and compositions of solvents can be adjusted to balance the rheology of the solution, the delivery rate of the metal element into the flame and the ability to deliver the sufficient fuel to maintain the flame at desired temperatures.

In addition, liquid metal precursors, such as TiC₄ or titanium isopropylate, can be delivered as an aerosol without a liquid solvent. Similarly, a mixture of liquid metal precursors can be mixed together for delivery as an aerosol. The fuel can be delivered in a separate channel using the multiple channel delivery nozzles described herein.

A wide range of organic liquids are suitable as fuels. In flame spray pyrolysis, fuel with dissolved metal precursor or an emulsion of a fuel and water soluble metal precursor have been delivered through a single channel of a nozzle. Based on the precursor-fuel systems described herein, either water soluble organic liquids or non-water soluble organic liquids can be used as fuels that are combined with metal precursor compositions to form precursor solutions. Similarly, different fuels can be delivered through separate channels of a multiple channel nozzle, and fuel may be delivered out of a channel of a nozzle while precursor without fuel can be delivered out of a separate channel. Therefore, fuels can be selected with greater flexibility.

In improved precursor-fuel systems with a single channel nozzle, a fuel can be used in forming a precursor solution in which the fuel is water soluble or dissolves a reasonable amount of water or is water miscible. These fuels can be referred to as water compatible in that they are used to form aqueous solutions. As used herein, an aqueous solution comprises at least about 2 weight percent water, in further embodiments, at least about 3 weight percent water, and in further embodiments at least about 5 weight percent water. If the only liquid fuel is delivered with the aqueous solution, generally the solution comprises at least about 50 weight percent fuel, and in further embodiments from about 60 to about 95 weight percent organic liquids. The precursor metal ion concentration in the solution generally is at least about 0.01 molar, in further embodiments at least about 0.1 molar, and in other embodiments at least about 0.4 molar. A person of ordinary skill in the art will recognize that additional ranges of water and fuel amounts and precursor concentrations within the explicit ranges above are contemplated and are within the present disclosure.

It has been found that water compatible fuels can be supplied that provide desired high flame temperatures. For example, diethylene glycol monobutyl ether, 2-ethyl hexanoic acid, acetone, ethylene glycol and acetonitrile are each miscible with water and contribute heats of combustion that facilitate the formation of high temperature flames. Ethanol and other alcohols can be used to adjust the viscosity of aqueous solutions while contributing a reasonable amount of additional heat of reaction. In some embodiments, it is desirable to include an organic liquid that has a heat of combustion in pure form of at least about 10 kJ/gram. A person of ordinary skill in the art will recognize that additional ranges of heats of combustion within the explicit ranges above are contemplated and are within the present disclosure. Water does not contribute to the heat of combustion and water removes heat form the flame due to evaporation and heating of the water. However, even modest amounts of water can contribute in important ways to the solubility of the metal precursor compositions while the available fuels still provide for reaching the desired high temperatures in the flame.

The use of a multiple channel nozzle provides additional flexibilities. For example, fuel separate from a precursor can be delivered through a channel. In this way, a high heat of combustion fuel, such as xylene, can be delivered through a channel without consideration if it is suitable for dissolving a metal precursor. Since the separately delivered fuel can supply the necessary heat of combustion, the liquid precursor solution delivered from a separate channel may or may not include a fuel. Thus, a neat liquid metal precursor composition or an aqueous precursor solution without an organic liquid can be delivered through a channel of the nozzle. Alternatively or additionally, some organic liquids or organic solids can be dissolved in the aqueous solution to provide additional heat of combustion or to alter the rheology of the solution. Suitable solids include, for example, citric acid, glycine, urea, acetic acid, sugars, derivatives thereof, and the like. Some of the solids in the solution can also act as complexing/chelating agents for stabilizing the metal ions against precipitation. In some embodiments, pH adjustment can also facilitate stabilizing the solution against precipitation.

The use of a multiple channel nozzle provides the ability to deliver separate metal precursors from distinct channels of the nozzle. Due to the ability to separately deliver different metal precursors, metal compositions can be used that are not compatible in the same solution. One or more of the solutions may be aqueous solutions, or one or more of the solutions may comprise non-aqueous organic solvents. Thus, there is great flexibility in selecting the individual precursors for providing a particular metal element into the flame without coordinating the selection based on other metals to be delivered for the formation of multiple metal oxide particles.

As noted above, the average temperature of the flame can be measured. However, the selection of the fuel can be further assisted through calculations to estimate the flame temperature. The calculations can be based on the assumptions of adiabatic conditions at constant pressure ΔH_{reactants}=ΔH_{products}, complete combustion of the fuel with excess oxygen, and no heat loss due to radiative cooling or quenching by ambient air. The total energy of the reactants is calculated based on the flow rates and the enthalpy of formation. An iterative calculation is performed to obtain the flame temperature to match the adiabatic condition. The enthalpy of formation of the metal compositions is neglected. The adiabatic flame temperature for fuel-water mixture, or having the fuel delivered through a separate channel of the nozzle, with ≦25 volume percent water was calculated to be >2500° C. for the following fuels: xylene, toluene, methane, hexane, 2-ethyl hexanoic acid, diethyelene glycol monobutyl ether, tetrahydro furan, and ethylene. The adiabatic flame temperature for fuel-water mixture with ≦25 volume percent water was calculated to be >2000° C. and <2500° C. for the following fuels: acetonitrile, ethanol, and acetone. The adiabatic flame temperature without any water component was calculated to be >2500° C. for the following fuels: ethylene glycol, citric acid, acetic acid, glycine, hydrogen and urea.

### Particle Properties and Compositions

In general, inorganic particles can be formed with any stable oxide composition. For precursor systems comprising a plurality of metal/metalloid elements, the resulting oxides can form complex mixed metal oxide particles if the mixed metal oxide composition corresponding to the overall precursor composition is stable under the conditions of the flame. In some embodiments, the product oxide particles have an average diameter of no more than about one micron, and in further embodiments it may be desirable to form nanoscale particles, e.g., particle collections with average diameters of no more than 100 nm. Tungsten oxide and metal tungsten oxide compositions, which can be referred to as tungsten bronzes, are a class of materials with interesting properties that can be produced using the methods described herein.

Using flame spray pyrolysis, a collection of product submicron/nanoscale oxide particles generally may have an average diameter for the primary particles of less than about 500 nm, in some embodiments from about 2 nm to about 100 nm, alternatively from about 2 nm to about 75 nm, or from about 2 nm to about 50 nm. A person of ordinary skill in the art will recognize that other ranges within these specific ranges are covered by the disclosure herein. Primary particle diameters are evaluated by transmission electron microscopy.

As used herein, the term “particles” refer to physical particles, which are unfused, so that any fused primary particles are considered as an aggregate, i.e. a physical particle. If there is hard fusing of some primary particles, these hard fused primary particles form correspondingly larger physical particles. The primary particles can have a roughly spherical gross appearance, or they can have rod shapes, plate shapes or other non-spherical shapes. Upon closer examination, crystalline particles may have facets corresponding to the underlying crystal lattice. Diameter measurements on particles with asymmetries are based on an average of length measurements along the principle axes of the particle. In general, the product particles can have good uniformity with respect to the size distribution, phase composition and chemical composition under appropriately selected flame conditions.

Even though the particles may form loose agglomerates, the nanometer scale of the particles is clearly observable in transmission electron micrographs of the particles. The particles generally have a surface area corresponding to particles on a nanometer scale as observed in the micrographs. Furthermore, the particles can manifest unique properties due to their small size and large surface area per weight of material. For example, the absorption spectrum of crystalline, nanoscale TiO₂ particles is shifted into the ultraviolet.

The particles can be characterized by the surface area as measured by the BET process known in the art. In some embodiments, the powders of the particles can have a BET surface area of at least about 10 m²/g, in further embodiments, from about 20 m²/g to about 100 m²/g, and in additional embodiments form about 25 m²/g to about 100 m²/g. A person of ordinary skill in the art will recognize that additional ranges of BET surface area within the explicit ranges above are contemplated and are within the present disclosure. The surface area can reflect the particle size as well as the primary particle size.

Because of their small size, the particles tend to form loose agglomerates due to van der Waals and other electromagnetic forces between nearby particles. These loose agglomerates can be dispersed in a dispersant to a significant degree. The size of the dispersed particles can be referred to as the secondary particle size. The primary particle size, of course, is the lower limit of the secondary particle size for a particular collection of particles, so that the average secondary particle size can be approximately the average primary particle size if the primary particles are substantially unfused and if the particles are effectively completely dispersed in the liquid.

The secondary or agglomerated particle size may depend on the subsequent processing of the particles following their initial formation and the composition and structure of the particles. In particular, the particle surface chemistry, properties of the dispersant, the application of disruptive forces, such as shear or sonic forces, and the like can influence the efficiency of fully dispersing the particles. The formation of particle dispersions is described further below.

A basic feature of successful application of flame spray pyrolysis for the production of desired submicron particles is the generation of a reactant stream containing one or more metal/metalloid precursor compounds and an oxygen source, generally O₂. The oxygen source, which also serves as an oxidizing agent, in the flow oxidizes the fuel to supply heat to the flame and generally is a source of oxygen atoms for the metal/metalloid oxide product particles. The metal/metalloid precursor composition may also provide additional oxygen atoms into the flow. As the flow proceeds in the chamber and the fuel is consumed, the inorganic particles are rapidly quenched with particles present in the resulting product particle stream, which is a continuation of the reactant stream. The concept of a stream has its conventional meaning of a flow originating from one location and ending at another location with movement of mass between the two points, as readily distinguished from movement in a mixing configuration that involves no net flow.

In general, nanoparticles produced by flame spray pyrolysis can be subjected to additional processing to alter the nature of the particles, such as the composition and/or the crystallinity. For example, the nanoparticles can be subjected to heat processing in a gas atmosphere prior to use. Under suitably mild conditions, heat processing is effective to modify the characteristics of the particles without destroying the nanoscale size or the narrow particle size distribution of the initial particles. For example, heat processing of submicron vanadium oxide particles is described in U.S. Pat. No. 5,989,514 to Bi et al., entitled “Processing Of Vanadium Oxide Particles With Heat,” incorporated herein by reference.

It has been found that good quality submicron metal/metalloid oxide particles can be synthesized using flame spray pyrolysis. The composition of the product particles is determined through the metal and/or metalloid elements and their relative amounts introduced into the flame in the precursor aerosol. If there is a single metal/metalloid element in the reactant flow, then the product metal/metalloid oxide particles incorporate that element. However, it is possible to introduce a plurality of metal and/or metalloid elements to form product particles with more complex compositions. The precursor systems described herein provide for greater flexibility for the selection of metal and/or metalloid precursor composition for delivery into the flame. With this precursor selection flexibility, a large number of product oxide compositions can be selected. The selected metal and/or metalloid elements can generally form stoichiometric, non-stoichiometric and/or dopant elements within the product oxide particles.

Metal elements for incorporation into the oxide submicron particles include the transition metals, alkali group 1 elements, alkali earth group 2 elements, and post-transition metals, Al, Ga, In, Sn, Sb, Tl, Pb and Bi as well as radioactive post-transition metal elements. Metalloid elements have overall properties intermediate between the metals and non-metals. Metalloid elements include silicon, boron, arsenic, germanium and tellurium. In general, the product particles can comprise 1, 2, 3, 4, 5, 6, 7, 8 or more metal and/or metalloid elements in the oxide. In complex particle compositions, one or more of the metal/metalloid elements can be dopants and/or non-stoichiometric elements associated with a host composition.

Some metal oxide compositions are of commercial interest due to their particular physical properties. For the formation of some display structures and some solar cell designs, materials reasonably transparent to visible light and electrically conductive are used to form transparent electrodes. Two materials that have found significant application in transparent electrode applications include tin-doped indium oxide, commonly referred to as indium tin oxide or ITO, and antimony doped tin oxide or ATO. These materials can provide reasonable electrical conductivity in thin films. Water soluble salts of the metals are available for the synthesis of ITO and ATO using the flame spray pyrolysis processes described herein.

It has also been discovered that tungsten bronzes composition can provide reasonable electrical conductivity and transparency to visible light if the composition of the bronze is appropriately balanced. In some embodiments, tungsten bronzes have the composition MₓWO₃, where M is a non-tungsten metal and 0<x<1. In traditional tungsten bronzes, M is an alkali metal element, Li, Na, K, Rb and/or Cs, although other metals and Si can be introduced into the compositions as described further below. Appropriate values for x may depend on the particular metal, M. Traditional tungsten bronzes are described in U.S. Pat. No. 3,505,108 to Mochel, entitled Tungsten Bronze Films,” incorporated herein by reference. Tungsten bronze materials have been described as non-stoichiomteric compositions. The formation of tungsten bronzes with non-alkali metals using a plasma reactor is described in published U.S. patent application 2005/0271566 A to Yadav, entitled “Tungsten Comprising Nanomaterials and Related Nanotechnology,” incorporated herein by reference. Metal tungsten oxide compositions with a more general composition of MₓW_{y}O_{z}, with 0.001≦x/y≦1 and 2.0<z/y≦3.0 and M is H, alkali metals, alkali earth metals, rare-earth metals, Mg, Zr, Cr, Mn, Fe, Ru, Co, Rh, Ir, Ni, Pd, Pt, Cu, Ag, Au, Cd, Al, Ga, In, Ti, Si, Ge, Sn, Pb, Sb, B, F, P, S, Se, Br, Te, Nb, V, Mo, Ta, or Re is described in published U.S. patent application 2006/0008640A to Chonan et al., entitled Laminated Structure for Shielding Against Solar Radiation,” incorporated herein by reference. As contemplated herein, combinations of a plurality of non-tungsten metals can be used for the metal tungsten oxide compositions, such as MₓW_{y}O_{z} where M is a non-tungsten metal, a metalloid or a combination thereof, x/y is at least about 0.01 and no more than about 0.99 and z/y is at least about 2 and no more than about 3. If z/y is equal to 3, then the composition is MₓWO₃, which is described above. Elements for M of particular interest include, for example, alkali metals (Li, Na, K, Rb, and Cs), alkali earth metals (Be, Mg, Ca, Sr and Ba), Y, Sb, Bi, Si, Ti and first row transition metals (Sc, Ti, V, Cr, Mn, Fe, Co, Ni, Cu and Zn).

Tungsten bronze materials have been found to be useful as infrared absorbing films. Tungsten oxide is substantially transparent to visible and infrared light. As the amount of added metal is increased along with oxygen vacancies, the material absorbs infrared light and gradually visible light. If the amount of added metal is appropriately selected, the material remains reasonably transmitting of visible light while being a good absorber of infrared light.

The incorporation of the added metal and oxygen vacancies into the tungsten oxide can also result in increasing electrical conductivity. Of course, as the amount of electronic defects is increased the transparency to visible light decreases. It has been discovered that these features can be balanced so that a desired level of electrical conductivity can be achieved while maintaining a reasonable amount of transparency to visible light. Thus, appropriately selected tungsten bronzes can be used as suitable alternatives to ITO, ATO and other transparent electrode materials.

### Particle Dispersions and Composites

The metal/metalloid oxide particles formed with flame spray pyrolysis generally can be well dispersed into an appropriately selected liquid. The dispersing liquid can be selected to form a better quality dispersion through compatibility with the particle surface properties. Also, the particles can be surface modified in some embodiments to facilitate the dispersion of the particles and/or to stabilize the resulting dispersion. The dispersions can also be used to form polymer composites. The dispersions, with or without a polymer component, can be used to form coatings or printed to form structures, which in some embodiments can be used to form transparent electrodes.

To obtain a good dispersion, the particles may or may not involve surface modification. Surface modification can facilitate the formation of good dispersions in a wider range of liquids. In some embodiments, the dispersion can be further stabilized by surface modifying the inorganic oxide particles. The surface modifying agents of particular interest can form chemical bonds with the particle surface. Through appropriate selection of the dispersing liquid and the particle surface properties, stable dispersions can be formed at reasonable concentrations.

The surface modification of inorganic oxide particles, e.g., tungsten bronze particles, can improve stability of the particle dispersions and provide for dispersion of the particles in a wider range of liquids and potentially at higher concentrations. While some surface modifiers can merely coat the surface, improved stability of the coated particles may be accomplished with surface modifiers that are chemically bonded to the surface. In particular, alkoxysilanes react with metal/metalloid oxides to form M—O—Si bonds to form a stable surface coating with the release of a corresponding compound from the displaced alkoxy silane functional group. An improved surface coating can be achieved with improved —OH functional group coverage on the surface of the metal/ metalloid oxide particles. The surface modification process can involve a switch of dispersants. For convenience of terminology, a surface modifying compound refers to a compound that adds at least 3 atoms to the particle surface when it bonds to the particle surface, to distinguish compositions, that modify the surface of a metal/metalloid oxide particle such as through the introduction of an —OH group.

A range of surface modifying compounds can be used to chemically bond to the metal/metalloid oxide particle surfaces. Suitable functional groups for bonding to inorganic particles with different compositions are described in U.S. Pat. No. 6,599,631 to Kambe et al, entitled “Polymer-Inorganic Particle Composites,” incorporated herein by reference. Alkoxysilanes provide stable bonding to metal/metalloid oxide particles. In particular, trialkoxysilanes provide very stable bonding to the particle surface with potentially three points of bonding. The fourth side chain of the trialkoxysilanes provides the ability to influence the dispersability and other surface properties of the surface modified inorganic particles. Specifically, the fourth side chain of the silane can be selected to improve disperability in a selected solvent and/or to provide a reactive functional group for further processing. Similarly, polydialkoxysiloxy silanes provide stable bonding with the ability of each monomer unit to form two bonds to the particle. The siloxane polymer can wrap around the particles during the bonding process. In addition to alkoxy silanes, chemical compounds with other functional groups can form bonds to metal/metalloid oxide particles. Specifically, compounds with chlorosilicate (—SiCl) groups, some amine groups, carboxylic acid groups and hydroxide groups can also bond to metal/metalloid oxide particle surfaces. Additional functional groups of these compounds can be similarly selected to yield desirable properties for the resulting surface modified particles.

With respect to the alkoxy side chains of silanes, methoxy groups and ethoxy groups have been found to be effective in reacting with inorganic oxide particle surfaces, and a range of compounds with these functional groups are commercially available. Suitable fourth functional groups for the trialkoxy silanes include, for example, alkyl groups, epoxide groups (—(CH₂)ₙCHCH₂O_{bridge}), methacryloxyalkyl (—(CH₂)ₙOOC═CH₂), isocyanate (—(CH₂)ₙNCO), thiol (—(CH₂)ₙSH), acetyl (—(CH₂)ₙOOCCH₃), hydroxybenzophenyl (—(CH₂)ₙOC₆H₅(OH)COC₆H₅), allyl (—CH₂CH═CH₂), and phenethyl (—(CH₂)ₙC₆H₅). In general, the surface modifying compound can be coated at a coverage from less than a monolayer to four or more monolayers as well as values between. The amount of coverage can be estimated based on the surface area of the particles and the amount of compound that can be expected to pack along the particle surface.

One of at least two processes can be used to perform the surface modification. In one approach, an unstable, higher concentration dispersion can be formed with the oxide particles, and the surface modification is performed to stabilize the higher concentration dispersion. However, better particle dispersions generally are obtained through first forming a dilute, relatively stabile dispersion of the particles without surface modification and then performing the surface modification.

In the direct approach, the liquid is selected to balance the dispersion of the unmodified particles, the solubility of the surface modifying compound unbound to the particles and the dispersion of the particles following surface modification. Generally, the liquid is not a particularly good dispersant for the unmodified particles. Similarly, the liquid may not be a good solvent for the surface modifying agent. But if the surface modifying agent is somewhat soluble in the liquid and the unmodified particles can be dispersed with mixing, the surface modification reaction can be performed. As the particles become surface modified, the dispersion may stabilize as the reaction proceeds.

Better dispersion results generally can be obtained if the inorganic particles without a surface modifier are first stably dispersed with a desirably small average secondary particle size. Alcohols and water/alcohol blends generally are good dispersants for the unmodified metal/metalloid oxide particles as synthesized by some approaches. The surface modifying compound can be added directly into the alcohol or water/alcohol blend if it has some solubility, or the surface modification compound can be dissolved into a solvent that is miscible with or soluble in the liquid of the particle dispersion. Suitable alcohols generally include, for example, small aliphatic alcohols, such as methanol, ethanol, propylene glycol, butanediol, mixtures thereof and the like. After the surface modification is complete, the particles can be transferred to a different dispersing liquid as described below. Upon surface modification, the inorganic oxide particles can be dispersed in a broader range of solvents and solvent blends through the matching of the chemical properties of the surface modifying agent with the liquid. Thus, following surface modification, the particles can be well dispersed in a range of less polar solvents, such as ethyl lactate, n-methyl pyrrolidinone, gamma-butyl lactone, and the like. The surface modified particles can be stored or shipped in a liquid suitable for further processing.

In general, to change dispersing liquids, it has been found effective to settle the particles by forming a liquid mixture in which the stability of the dispersion is lost. Centrifugation or filtration can be used to efficiently separate the particles from the liquid once they are no longer stably dispersed. If the particles are centrifuged, the liquid is decanted from the precipitated particles. The particles can be washed one or more times with a selected dispersing liquid to remove residual amounts of the original liquid. Then, the particles can be redispersed in the selected liquid. In this way, the liquid can be changed for a later processing step through the selection of a surface modifier that facilitates dispersion in the selected liquid.

Following surface modification and/or at other stages of the dispersion process, the dispersion can be filtered to remove contaminants and or any stray unusually large particles. Generally, the filter is selected to exclude particulates that are much larger than the average secondary particle size so that the filtration process can be performed in a reasonable way. In general, the filtration processes have not been suitable for overall improvement of the dispersion quality. Suitable commercial filters are available, and can be selected based on the dispersion qualities and volumes.

Better dispersions are more stable and/or have a smaller secondary particle size indicating less agglomeration. As used herein, stable dispersions have no settling without mixing after one hour. In some embodiments, the dispersions exhibit no settling of particles without mixing after one day and in further embodiments after one week, and in additional embodiments after one month. In general, dispersions with well dispersed particles can be formed at concentrations of at least up to 30 weight percent inorganic particles. Generally, for some embodiments it is desirable to have dispersions with a particle concentration of at least about 0.05 weight percent, in other embodiments at least about 0.25 weight percent, in additional embodiments from about 0.5 weight percent to about 30 weight percent and in further embodiments from about 1 weight percent to about 20 weight percent. A person of ordinary skill in the art will recognize that additional ranges of stability times and concentrations within the explicit ranges above are contemplated and are within the present disclosure.

The dispersions can include additional compositions besides the metal/metalloid particles and the dispersing liquid or liquid blend to modify the properties of the dispersion to facilitate the particular application. For example, property modifiers can be added to the dispersion to facilitate the deposition process. Surfactants can be effectively added to the dispersion to influence the properties of the dispersion.

In general, if processed appropriately, for dispersions with well dispersed particles, the average secondary particle size can be no more than a factor of four times the average primary particle size, in further embodiments no more than about 3 times the average primary particle size and in additional embodiments no more than about 2 times the average primary particle size. In some embodiments, the volume-average particle size is no more than about I micron, in further embodiments no more than about 500 nm, in additional embodiments no more than about 250 nm, in other embodiments from about 2 nm to about 100 nm and in some embodiments from about 5 nm to about 50 nm. With respect to the particle size distribution, in some embodiments, essentially all of the secondary particles can have a size no more than 5 times the volume-average secondary particle size, in further embodiments no more than about 4 times the volume-average particle size and in additional embodiments no more than about 3 times the volume-average particle size. Furthermore, the DLS particle size distribution by volume can have in some embodiments a full width at half-height of no more than about 50 percent of the Z-average particle size. Also, the secondary particles can have a distribution in sizes such that at least about 95 percent of the particles have a diameter greater than about 40 percent of the average particle size and less than about 250 percent of the average particle size. In further embodiments, the secondary particles can have a distribution of particle sizes such that at least about 95 percent of the particles have a particle size greater than about 60 percent of the average particle size and less than about 200 percent of the average particle size. A person of ordinary skill in the art will recognize that additional ranges of particle sizes and distributions within the explicit ranges above are contemplated and are within the present disclosure.

Secondary particles sizes within a liquid dispersion can be measured by established approaches, such as dynamic light scattering. Suitable particle size analyzers include, for example, a Microtrac UPA instrument from Honeywell based on dynamic light scattering, a Horiba Particle Size Analyzer from Horiba, Japan and ZetaSizer Series of instruments from Malvern based on Photon Correlation Spectroscopy. The principles of dynamic light scattering for particle size measurements in liquids are well established.

Dynamic light scattering involves the calculation of a Z-average particle size based on scattering intensity, and Z-average particle sizes can be converted into volume average particle sizes. Specifically, the Z-average particle size is based on a scattering intensity weighted distribution as a function of particle size. Evaluation of this distribution is prescribed in ISO International Standard 13321, Methods for Determination of Particle Size Distribution Part 8: Photon Correlation Spectroscopy, 1996, incorporated herein by reference. The Z-average distributions are based on a single exponential fit to time correlation functions. However, small particles scatter light with less intensity relative to their volume contribution to the dispersion. The intensity weighted distribution can be converted to a volume-weighted distribution that is perhaps more conceptually relevant for evaluating the properties of a dispersion. For nanoscale particles, the volume-based distribution can be evaluated from the intensity distribution using Mie Theory. The volume-average particle size can be evaluated from the volume-based particle size distribution. Further description of the manipulation of the secondary particle size distributions can be found in Malvern Instruments—DLS Technical Note MRK656-01, incorporated herein by reference.

Suitable coating approaches for the application of the dispersions include, for example, spin coatings, dip coating, spray coating, knife-edge coating, extrusion or the like. Coating approaches generally are used to cover a substrate, although a mask or the like can be used to limit the deposition locations following removal of the mask. In general, any suitable coating thickness can be applied, although in embodiments of particular interest, coating thickness can range from about 200 nm to about 1000 microns and in further embodiments from about 500 nm to about 250 microns. A person of ordinary skill in the art will recognize that additional ranges of thicknesses within the particular ranges above are contemplated and are within the present disclosure.

Similarly, a range of printing techniques can be used to print the dispersion used as an ink into a pattern on a substrate. Suitable printing techniques include, for example, screen printing, inkjet printing, lithographic printing, gravure printing and the like. Suitable substrates include, for example, polymers, such as polysiloxanes, polyamides, polyimides, polyethylenes, polycarbonates, polyesters, combinations thereof, and the like, ceramic substrates, such as silica glass, and semiconductor substrates, such as silicon or germanium substrates. The composition of the substrates influences the appropriate range of processing options following deposition of the dispersion/ink.

The metal/metalloid oxide particles can be blended with a polymer to form a composite. The polymer matrix functions as a binder for the particles. Generally, better quality composites can be formed if the polymer is blended with the inorganic particles in a dispersion. In general, it is desirable for the inorganic particles to be well dispersed within the composite since good dispersion can result in improved and more predictable functionality for the composite. This uniformity of the particle distribution can be indirectly inferred through the resulting properties of the composite, and the particles can be observed in the composite, for example, using transmission electron microscopy for films and/or scanning electron microscopy for cross sections and surfaces of thicker films.

Specifically, it has been found that a reduction of light scattering can be observed from the composite if the particles are more uniformly distributed in the composite. Optically transparent inorganic particle-polymer composites and improved metal/metalloid oxide submicron particles dispersions are described further in published U.S. patent application 2008/0150184A to Chiruvolu et al., entitled “Composites of Polymers and MetaVMetalloid Oxide Nanoparticles and Methods of Forming These Composites,” incorporated herein by reference.

With respect to the formation of composites for use as transparent electrodes, it is generally desirable to have relatively high particle loadings to improve the electrical conductivity. The polymer functions as a binder, and a range of polymers can be used that are substantially transparent to visible light. With good uniformity of the dispersion of the particles, the electrical conductivity for a particular loading should be improved as well as the transparency.

With respect to the loading to obtain reasonable electrical conductivity from the composites, the composites generally have a particle loading of at least about 15 percent by volume, in further embodiments from about 18 volume percent to about 75 volume percent and in additional embodiments from about 20 volume percent to about 60 volume percent particle loadings in the composite. Volume percents are evaluated from the weights of the component materials, which are used to obtain component volumes based on bulk densities. A person of ordinary skill in the art will recognize that additional ranges of particle loading within the explicit ranges above are contemplated and are within the present disclosure.

To increase the electrical conductivity of the composite, it has been realized that the addition of nano-scale electrically conductive particles can improve the electrical conductivity of the composite without significantly decreasing the transmission of visible light. Suitably electrically conductive particles include, for example, conductive carbon, such as carbon black, elemental metal particles, such as silver powders or nickel powders, metal alloy particles, or combinations thereof. In particular, electrically conductive particles with an average particle size of no more than about 50 nm, and in further embodiments from about 2 nm to about 40 nm, and in additional embodiments from about 4 nm to about 30 nm average particle size can interface with the conductive inorganic oxide particles to improve the electrical conduction pathways through the material. The electrically conductive particles can be present in up to about 20 weight percent, in further embodiments from about 0.25 weight percent to about 15 weight percent, and in further embodiments from about 0.5 weight percent to about 12 weight percent. A person of ordinary skill in the art will recognize that additional ranges of particle size and loading for the electrically conductive particles are contemplated and are within the present disclosure.

Surface modifying moieties can have functional groups that form covalent bonds with functional groups of the organic binder. With these linkers, an effective crosslinking results with the particles incorporated into the crosslinked network. This crosslinking can facilitate the formation of more uniform composites and can stabilize the composite. Crosslinked inorganic particle-polymer composites are described further in U.S. Pat. No. 6,599,631 to Kambe et al., entitled “Polymer-Inorganic Particle Composites,” incorporated herein by reference. In general, the organic binder can possess functional side groups and/or terminal sites for polymeric binders that can be chemically bonded with the inorganic particles and/or with functional groups of a surface modifying composition.

Suitable polymers include, for example, organic polymers, organo-silicon-based polymers and mixtures thereof. Suitable organic polymers include, for example, polyamides (nylons), polyimides, polycarbonates, polyurethanes, polyacrylonitrile, polyacrylic acid, polyacrylates, polyacrylamides, polyvinyl alcohol, polyvinyl chloride, heterocyclic polymers, polyesters, modified polyolefins and mixtures and reasonable copolymers thereof Composites formed with nylon polymers, i.e., polyamides, and inorganic nanoparticles can be called Nanonylon™. Suitable organo-silicon-based polymers include, for example, polysilanes and polysiloxane (silicone) polymers, such as poly(dimethylsiloxane) (PDMS) and poly(methylphenyl siloxane)(PMPS). Polysiloxanes can be desirable polymers because of their transparency to visible and ultraviolet light, high thermal stability, resistance to oxidative degradation and their hydrophobicity. Other inorganic polymers include, for example, phosphazene polymers (phosphonitrile polymers). The polymers can be crosslinked to provide desired mechanical properties to the composite.

The polymer can be included in the particle dispersion with appropriate mixing to form a liquid composition suitable for forming the composite. The dispersion with the polymer and inorganic particles can be formed appropriately into a coating, film or other structure. Specifically, extrusion, molding, casting, calandering, coating, printing techniques, combinations thereof or the like can be used as appropriate.

### Transparent Electrodes

As noted above, metal/metalloid oxide particles suitable for forming transparent electrodes can be synthesized using flame spray pyrolysis. Suitable particles can comprise, for example, indium tin oxide, antimony tin oxide or a metal tungsten oxide. The particles can be formed into a dispersion to facilitate the formation of the electrode structure. The electrode can comprise a composite of the particles with a polymer or a film of the material formed form the powder.

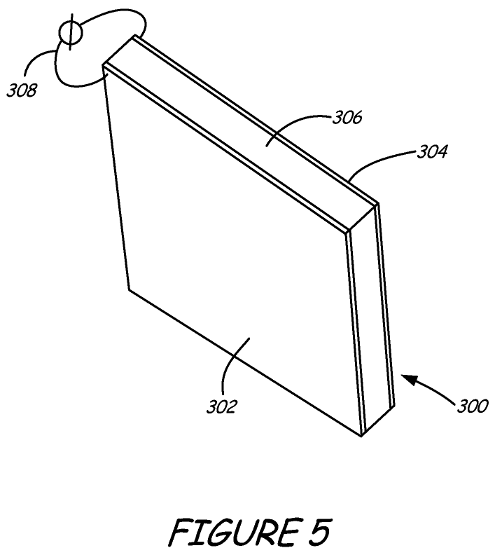

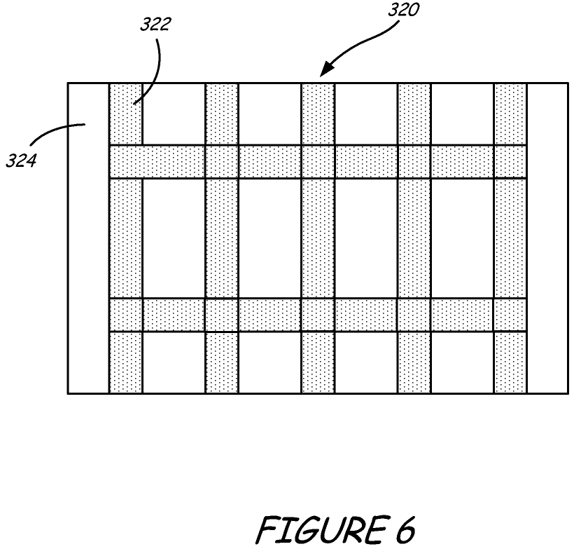

Referring to FIG. 5, a device 300 is shown with a transparent electrode film 302, a counter electrode 304 and a body of the device 306. Transparent electrode 302 and counter electrode 304 are connected through an external circuit 308. Counter electrode 304 may or may not be a transparent electrode. An alternative embodiment of a device is shown in FIG. 6. Referring to FIG. 6, device 320 comprises a transparent electrode grid 322 on device body 324. In device 320, transparent electrode 322 does not cover portions of the device so that no attenuation of light is involved with the uncovered portions. Devices 300 and 320 independently can be light emitting devices, such as displays or portions thereof, or light receiving devices, such as light measuring diodes or solar cells.

Transparent electrodes 302 and 322 as well as other embodiments thereof, can be films of the transparent, electrically conductive material or a polymer composite comprising the transparent, electrically conductive metal/metalloid oxide powders. To make films, the particles can be deposited from a dispersion. Suitable deposition approaches include, for example, painting, spray coating, dip coating, spin coating, extruding, knife coating or the like or combinations thereof. Upon removal of the dispersing liquid, the particles can be sintered and/or pressed into a film if the substrate has a sufficiently high temperature tolerance so that the transparent, conductive particles can be sintered without damaging the substrate. The heating can be performed in an oven or using other appropriate heating approaches.

Films of tungsten oxides of the formula MₓW_{y}O_{z}, with the parameters as described above, for the formation of transparent electrodes alternatively can be formed, for example, by physical vapor deposition, chemical vapor deposition, sputtering, spray drying, or sol-gel approaches. Targets for sputtering deposition can be fabricated using corresponding particles that are pressed and/or sintered at appropriate temperatures above the softening point, which can be lowered through the application of pressure. For the formation of sputtering targets, the particles can have an average diameter of no more than 10 microns.

If the transparent electrodes are formed from polymer composites, the formed electrodes can be cured to stabilize the structure. Curing generally is selected to be appropriate for the particular organic composition, e.g., polymer, and the curing process can involve more than one step. For example, in some embodiments, curing can be simply drying the ink. Drying to remove solvent and other volatile compounds, such as some processing additives, can be performed just by exposure to air, by reducing the pressure above the printed substrate, by heating the printed substrate at a modest temperature or by using a combination of these steps. In additional or alternative embodiments, curing can comprise heating the composite to higher temperatures to induce a chemical reaction in the matrix material, such as crosslinking of a polymer matrix. Heating generally is performed at a temperature at which other components of the structure are stable. Alternatively or additionally, the composite can be exposed to radiation to react the matrix material. For example, polymer matrix compositions can be exposed to ultraviolet radiation, electron beam radiation, corona radiation to crosslink the polymer.

### EXAMPLES

### Comparative Example

### Synthesis of CsₓWO₃ with a Non-Aqueous Solvent with a Single Channel Nozzle

Cesium tungsten oxide (CsₓWO₃) nanoparticles were synthesized using flame spray pyrolysis with a non-aqueous solvent system using the apparatus shown in FIG. 2.

A tungsten solution was prepared with 8 g of tungsten carbonyl (W(CO)₆) dissolved in 320 ml of tetrahydrofuran, and a cesium solution was prepared with 2.48 g of cesium acetate (CH₃COOCs) dissolved in 80 ml of ethanol-acetonitrile (50/50 v/v)). The precursor solution was prepared by mixing a quantity of the tungsten solution and the cesium solution in appropriate ratios to get x-values for CsₓWO₃ of 0, 0.1, 0.3, 0.5 and 0.7. The total metal ion molarity in the precursor solution was 0.06M. At higher tungsten concentrations, x=0.1 and 0.3, slight precipitation was observed in the precursor solution during the flame spray pyrolysis. The liquid was delivered at 5 ml/minute and O₂ dispersion gas flow rate was 5 slm for performing the flame spray pyrolysis. The phase composition of the synthesized CsₓWO₃ powders, as measured by X-ray diffraction, is shown in Table 1. These results match the trends described by Oi et al., “Hexagonal and Pyrochlore-Type Cesium Tungstate Synthesized from Cesium Peroxo-Polytungstate and Their Redox Chemistry,” Journal of Solid State Chemistry, 124: 176-185 (1993). These results indicate good homogeneity within the nanoparticles, e.g., uniform Cs distribution. BET surface areas of all five samples were measured to be between 90 and 110 m²/g.

TABLE 1
Phase Composition of CsₓWO₃ powders from Examples 1-5

| | x-value | | | | | | |
|---|---|---|---|---|---|---|---|
| FSP Method | 0 | 0.1 | 0.2 | 0.3 | 0.4 | 0.5 | 0.7 |
| Oi et al. | | | Hexagonal | Hexagonal | Hexagonal + | Pyrochlore | |
| | | | | | Pyrochlore | | |
| Comparative | Monoclinic | Monoclinic + | | Hexagonal | | Pyrochlore | Pyrochlore |
| Example | | Hexagonal | | | | | |
| Ex-5 | | Monoclinic + | Hexagonal | Hexagonal | Hexagonal | | |
| | | Hexagonal | | | | | |
| Ex-3 & 4 | | | | Hexagonal | | | |
| Ex-1 & 2 | | | | Hexagonal | | | |

### Example 1

### Synthesis of CsₓWO₃ (x=0.3) with a Single Liquid Channel Nozzle

Cesium tungsten oxide nanoparticles were synthesized using flame spray pyrolysis with an aqueous solvent.

The cesium tungsten oxide particles were synthesized using an apparatus essentially as shown in FIG. 2. The precursor solution was prepared by mixing a cesium solution (0.45 g cesium nitrate (CsNO₃) in 5 ml deionized water) and a tungsten solution (1.85 g ammonium meta tungstate hydrate ((NH₄)₆H₂W₁₂O₄₀·xH₂O) in 5 ml deionized water) with 15 ml ethylene glycol, followed by the drop by drop addition of 25 ml acetone under stirring. The mixture was a stable, single phase solution. The liquid was delivered at 5 ml/min, and the flow rate for O₂ dispersion gas was 5 slm (standard liters per minute) for spray flame pyrolysis. The estimated adiabatic flame temperature was 2160° C., based on the assumptions described above.

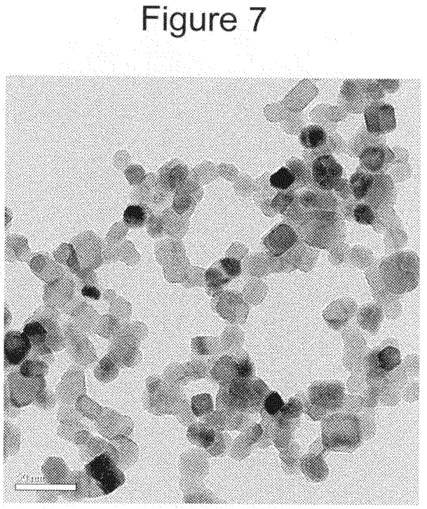

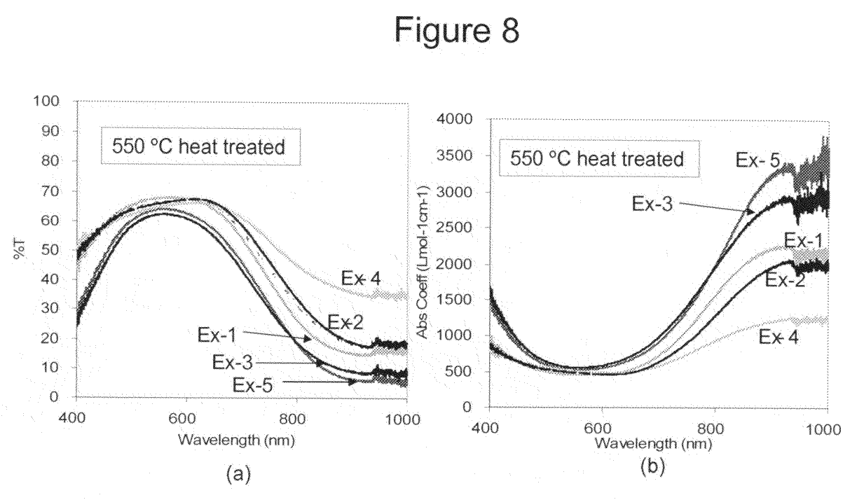

The resulting particles had a phase pure hexagonal structure as measured by X-ray diffraction and had a BET surface area of 60 m²/g, which corresponds to a calculated average particle size of 14 nm. The powders were reduced at 550° C. for 1 hr in a 3.9H₂/N₂ atmosphere to improve the crystallinity of the powders to form the infrared absorbing material. The BET surface area of the heat treated samples was measured to be 31 m²/g, which corresponds to a calculated average particle size of 27 nm. A transmission electron micrograph of the heat treated powders is shown in FIG. 7. A transmission spectrum of a 0.01 wt % dispersion of the heat treated powders in water is shown in FIG. 8. The transmission length within the dispersion was about 1 cm, which corresponds to an absorption coefficient of about 2228 Lmol⁻¹cm⁻¹ at 900 nm.

### Example 2

### Synthesis of CsₓWO₃ (x=0.3) with a Single Liquid Channel Nozzle and a Solid Organic Precursor Additive

This example demonstrates the ability to use alternative precursor solutions in the flame spray pyrolysis for the synthesis of cesium tungsten oxide.

Cesium tungsten oxide nanoparticles were synthesized using the same apparatus and flow conditions as described in Example 1. The precursor solution was prepared by mixing a cesium solution (1.38 g cesium nitrate (CsNO₃) in 6 ml deionized water), tungsten solution (5.68 g ammonium meta tungstate hydrate ((NH₄)₆H₂W₁₂O₄₀·xH₂O) in 6 ml deionized water), citric acid solution (1.38 g of citric acid in 6 ml deionized water), 30 ml diethylene glycol monobutyl ether and 10 ml NH₄OH solution.

The resulting particles had a phase pure hexagonal structure as measured by X-ray diffraction and had a BET surface area of 51 m²/g, which corresponds to a calculated average particle size of 16 nm. The powders were reduced at 550° C. for 1 hr in a 3.9H₂/N₂ atmosphere to improve the crystallinity of the powders and to form the infrared absorbing material. The BET surface area of the heat treated samples was measured to be 29 m²/g, which corresponds to a calculated average particle size of 29 nm. A transmission spectrum of a 0.01 wt % dispersion of the heat treated powders in water is shown in FIG. 8. The transmission length within the dispersion was about 1 cm, which corresponds to an absorption coefficient of about 1979 Lmol⁻¹cm⁻¹ at 900 nm.

### Example 3

### Synthesis of CsₓWO₃ (x=0.3) with a Dual Liquid Channel Nozzle

Cesium tungsten oxide nanoparticles were synthesized using flame spray pyrolysis with an aqueous solvent in dual liquid channel nozzle. This example demonstrates the ability to synthesize the particles using an aqueous precursor delivered through one channel of the nozzle and a fuel delivered through a separate channel of the nozzle.

The cesium tungsten oxide particles were synthesized using an apparatus essentially as shown in FIG. 3. The inner annulus of the nozzle was fed with a 0.2 molar aqueous solution of cesium nitrate (CsNO₃) and ammonium meta tungstate hydrate ((NH₄)₆H₂W₁₂O₄₀·xH₂O) at 1.2 ml/min, where the metal salts are dissolved in appropriate proportions to yield the desired composition. The outer annulus of the nozzle was fed with xylene at 4.8 ml/min. The flow rate for O₂ dispersion gas was 6 slm for flame spray pyrolysis. The estimated adiabatic flame temperature was 3422° C., based on the assumptions discussed above.

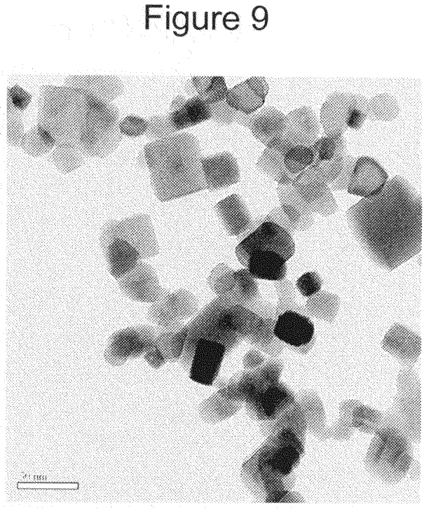

The resulting particle is phase pure of hexagonal structure as measured by X-ray diffraction and has a BET surface area of 85 m²/g, which corresponds to a calculated average particle size of 10 nm. The powders were reduced at 550° C. for 1 hr in 3.9H₂/N₂ atmosphere to improve the crystallinity of the powders to from the infrared absorbing material. The BET surface are of the heat treated sample was measured to be 27 m²/g, which corresponds to a calculated average particle size of 30 nm. A transmission electron micrograph of the heat treated powders is shown in FIG. 9. A transmission spectra of 0.01 wt % dispersion of heat treated powder in water is shown in FIG. 8. The transmission length within the dispersion was 1 cm, which corresponds to an absorption coefficient of about 2881 Lmol⁻¹cm⁻¹ at 900 nm.

### Example 4

### Synthesis of CsₓWO (x=0.3) with a Non-Aqueous Solvent with a Dual Liquid Channel Nozzle

This example demonstrates the ability to synthesize the particles using an aqueous precursor including an organic liquid delivered through one channel of the nozzle and a fuel delivered through a separate channel of the nozzle.

Cesium tungsten oxide nanoparticles were synthesized using the same apparatus and flow conditions as described in Example 3. The inner annulus of the nozzle was fed with a 0.2 molar solution of cesium nitrate (CsNO₃) and ammonium meta tungstate hydrate ((NH₄)₆H₂W₁₂O₄₀·xH₂O), both dissolved in 5 ml of deionized water, 4 ml of NH₄OH, 20 ml of ethanol amine at 1.2 ml/min, where the metals salts were dissolved in appropriate proportions to yield the desired composition. The outer annulus of the nozzle was fed with xylene at 4.8 ml/min. The flow rate for O₂ dispersion gas was 6 slm for flame spray pyrolysis.

The resulting particle is phase pure of hexagonal structure as measured by X-ray diffraction and has a BET surface area of 50 m²/g, which corresponds to a calculated average particle size of 17 nm. The powders were reduced at 550° C. for 1 hr in 3.9H₂/N₂ atmosphere to improve the crystallinity of the powders to from the infrared absorbing material. The BET surface area of the heat treated sample was measured to be 39 m²/g, which corresponds to a calculated average particle size of 22 nm. An optical transmission spectrum of 0.01 wt % dispersion of heat treated powder in water is shown in FIG. 8. The transmission length within the dispersion was 1 cm which corresponds to an absorption coefficient of about 1209 Lmol⁻¹cm⁻¹ at 900 nm.

### Example 5

### Synthesis of CsₓWO₃ (x=0.1, 0.2, 0.3, 0.4) with a Dual Liquid Channel Nozzle

Cesium tungsten oxide nanoparticles were synthesized using flame spray pyrolysis with a dual liquid channel nozzle fed with separate cesium and tungsten liquid feeds. This example demonstrates the ability to form particles with selected amounts of cesium.

The cesium tungsten oxide particles were synthesized using an apparatus essentially as shown in FIG. 3. The inner annulus of the nozzle was fed with cesium acetate (CH₃COOCs) dissolved in ethanol/acetonitrile (50/50 v/v) and the outer annulus of the nozzle was fed with ammonium meta tungstate hydrate ((NH₄)₆H₂W₁₂O₄₀·xH₂O) dissolved in ethanol/diethylene glycol monobutyl ether (50/50 v/v). The cesium feed was fed in the inner annulus at 2 ml/min and tungsten feed was fed in the outer annulus at 4 ml/min. The flow rate for O₂ dispersion gas was 6 slm for flame spray pyrolysis. For the synthesis of the selected particle composition, the composition of the cesium feed was selected to have 1.05 g, 1.92 g, 2.66 g, or 3.29 g of cesium acetate dissolved in 100 ml of ethanol/acetonitrile (50/50 v/v) for x=0.1, 0.2, 0.3, and 0.4, respectively. Composition of tungsten feed was selected to have 13.44 g, 12.31 g, 11.35 g, or 10.56 g of ammonium meta tungstate hydrate dissolved in 200 ml of ethanol/ diethylene glycol monobutyl ether (50/50 v/v) for x=0.1, 0.2, 0.3, and 0.4, respectively. The estimated adiabatic flame temperature was 3199° C., based on the assumptions discussed above.

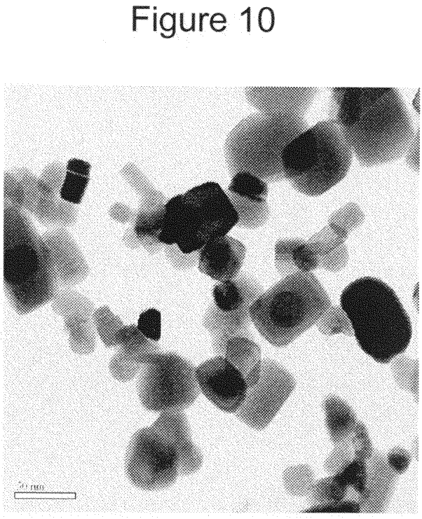

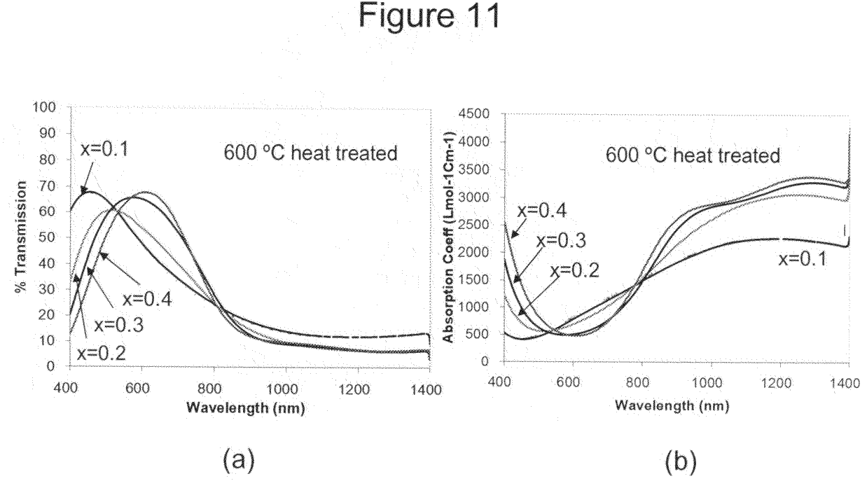

The phase composition of the synthesized CsₓWO₃ powders, as measured by X-ray diffraction, is shown in Table 1 along with the results of Examples 1-4. The phase compositions match the trends described by Oi et al., “Hexagonal and Pyrochlore-Type Cesium Tungstate Synthesized from Cesium Peroxo-Polytungstate and Their Redox Chemistry,” Journal of Solid State Chemistry, 124: 176-185 (1993). The results indicate good chemical homogeneity within the nanoparticles, i.e. cesium is distributed uniformly. The BET surface area of all four samples was measured to be between 68-81 m²/g, which corresponds to a calculated average particle size of 10-12 nm. The powders were reduced at 550° C. and 600° C. for 1 hr in 3.9H₂/N₂ atmosphere to improve the crystallinity of the powders to form infrared absorbing material. The BET surface area of the sample with x=0.3 with a heat treatment at 550° C. was measured to be 23 m²/g, which corresponds to a calculated average particle size of 27 nm. The BET surface area of the samples with x=0.1, 0.2, 0.3, 0.4 with a heat treatment at 600° C. was measured to be 44, 25, 20, 17 m²/g, respectively. A transmission electron micrograph of the sample powder with x=0.3 following heat treatment at 550° C. is shown in FIG. 10. An optical transmission spectrum is shown in FIG. 8 of a 0.01 wt % dispersion in water of the sample powder with x=0.3 following a 550° C. heat treatment. The transmission length within the dispersion was 1 cm, which corresponds to an absorption coefficient of about 3232 Lmol⁻¹cm⁻¹ at 900 nm. A transmission spectra are shown in FIG. 11 of 0.01 wt % dispersions in water of sample powders with x=0.1, 0.2, 0.3, 0.4 following a 600° C. heat treatment. The transmission length within the dispersion was 1 cm, which corresponds to an absorption coefficient of about 2450 Lmol⁻¹cm⁻¹ at 900 nm.

### Example 6

### Composite Coatings Formed from Cesium Tungsten Oxide Particles

This examples demonstrates the formation of a polymer composite film including tungsten bronze nanoparticles.

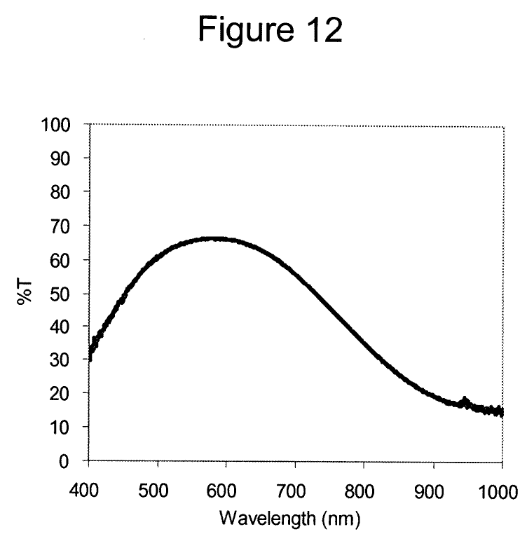

Cesium tungsten oxide nanoparticles synthesized according to the methods described in the examples above were combined with poly (methyl methacrylate)-methacrylate (PMMA-MA) polymer to form a composite film. Specifically, a PMMA-MA solution was prepared by dissolving 5 gm of PMMA-MA (75:25) in 100 ml isopropanol-water mixture (90:10 v/v). A 0.2 g quantity of CsₓWO₃ (x=0.3) powders described in Example 5 with heat treated at 600° C. were dispersed with ultrasonic mixing in 10 ml of PMMA-MA solution and spin coated three times on glass substrates at 700 rpm for 5 min. An optical transmission spectrum of the CsₓWO₃—PMMA-MA coating with 29wt % (about 5 vol %) nanoparticle content is shown in FIG. 12. The composite coating after 3 coats was adherent, about 1 μm thick.

### Example 7

### Composites Formed from Cesium Tungsten Oxide Particles

Cesium tungsten oxide nanoparticles and poly (methyl methacrylate)-methacrylate (PMMA-MA) powders were pressed together to form a composite tablet. The electrical resistance of the composite tablet formed was measured.

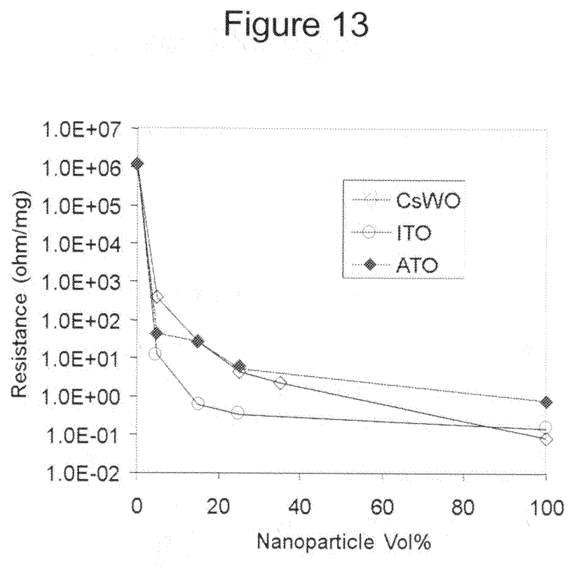

CsₓWO₃ (x=0.3) powders that were synthesized as described in Example 5 with a heat treated at 600° C. were mixed with PMMA-MA powders to get a composite with 0, 5, 15, 25, 100 vol % CsₓWO₃, based on a calculation involving the densities. The density of CsₓWO₃ (x=0.3) is 7.45 g/cm³, and the density of PMMA-MA 1.19 g/cm³. The mixed powder (60-80 mg) was then pressed into a pellet. The electrical resistance of the pellet was measured, using a device similar to that described in U.S. Pat. No. 7,323,121 by Burgard et al. entitled “Coating Material,” incorporated herein by reference. The weight normalized resistance (Ω/mg) as a function of percentage volume CsₓWO₃ is shown in FIG. 13. For comparison, the weight normalized resistance (Ω/mg) as a function of percentage volume values of nanoparticles of indium tin oxide (ITO) and antimony tin oxide (ATO) are also shown in FIG. 13. CsₓWO₃ (x=0.3) showed value of 8.7×10⁻² Ω/mg which was comparable to the values of nano-ITO (18.3 m²/g, 1.5×10⁻¹ Ω/mg) and nano-ATO (50.4 m²/g, 7.8×10⁻¹ Ω/mg).

### Example 8

### Cesium Tungsten Oxide Nanoparticles Coating

Cesium tungsten oxide nanoparticles were coated on glass substrate and heat-treated to form a coating. The electrical resistance of the coating is measured.

CsₓWO₃ (x=0.3) powders that were synthesized as described in Example 5 with a heat treatment at 600° C. were dispersed in isopropanol (at 1 wt % particle loading) with sonication in an ultrasonic bath. The dispersion was used to cast films on glass substrates with a wire drawing method. The cast films were heat treated at 500° C. for 5hrs in 3.9H₂/N₂ atmosphere. The resulting coating was 500 nm thick and transparent to visual inspection. The sheet resistance of the coating was measured by a 4-probe set-up using a Keithley 2001 Multimeter. The resistance of the coating was found to be 2×10³Ω initially and after 8 hrs the resistance increased to 20×10³Ω. The coating was found to be adherent by a tape-pull test.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

What is claimed is:

1. A method for synthesizing metal/metalloid oxide particles, the method comprising pyrolyzing in a flame a precursor composition comprising a water soluble metal composition, an organic liquid and at least about 2 weight percent water, wherein the water and organic liquid are blended within a un-phase separated blended liquid.

2. The method of claim 1 wherein the precursor composition comprises a plurality of metal elements.

3. The method of claim 1 wherein the organic liquid comprises diethylene glycol monobutyl ether.

4. The method of claim 1 wherein the precursor composition is delivered through a first stream of a multiple channel nozzle.

5. The method of claim 4 wherein a second precursor composition is delivered through a second channel of the nozzle for mixing with flow from the first channel within the flame.

6. The method of claim 4 wherein a organic fuel with no more than about 0.1 weight percent metal elements is delivered through a second channel of the nozzle into the flame.

7. The method of claim 1 wherein the metal composition comprises tungsten.

8. The method of claim 1 wherein the pyrolysis is performed in a burner chamber exposed to the ambient air.

9. A method for the synthesis of metal/metalloid oxide particles, the method comprising pyrolizing in a flame an aerosol of a first precursor composition that is delivered into the flame through a first channel of a multiple channel concentric nozzle, wherein a fuel, a second precursor composition or a combination thereof are delivered through a second channel of the nozzle.

10. The method of claim 9 wherein a second precursor composition is delivered through the second channel of the nozzle.

11. The method of claim 9 wherein the first precursor composition is dissolved in a solvent comprising an organic composition having a heat of combustion of at least about 10 kJ/g.

12. The method of claim 9 wherein the first precursor composition is dissolved in a solvent comprising at least about 5 weight percent water and wherein the second precursor composition is dissolved in a solvent comprising at least about 5 weight percent water.

13. The method of claim 9 wherein the first precursor composition comprises at least about 5 weight percent water.

14. The method of claim 9 wherein the first precursor composition comprises tungsten.

15. The method of claim 9 wherein the product metal/metalloid oxide particles have an average primary particle size of no more than about 250 nm.

16. The method of claim 9 wherein the pyrolysis is performed in a burner chamber exposed to the ambient air.

17. A flame spray pyrolsyis apparatus comprising a reaction chamber, a nozzle configured to deliver an aerosol within the reaction chamber, a particle collection system and a precursor delivery system, the reaction chamber comprising walls to at least partially enclose a flame and a flame ignition tool, the particle collection system configured to collect particles produced in the flame, the nozzle having a plurality of liquid delivery channels and the precursor delivery system operably connected to the nozzle deliver a plurality of liquids to distinct channels of the nozzle and a gas to impact on the liquid to form an aerosol.

18. A display device comprising an electronic circuit having a transparent electrode, the transparent electrode comprising a tungsten bronze composition having the formula MₓW_{y}O_{z}, where M is a non-tungsten metal element, Si or a combination thereof and x/y is greater than zero and no more than 0.99 and z/y is greater than 2 and no more than 3.

19. The display device of claim 18 wherein the transparent electrode comprises a layer of crystalline tungsten bronze with a thickness from about 50 nm to about 10 microns.

20. The display device of claim 18 wherein the transparent electrode comprises a composite, wherein the composite comprises a polymer and particles comprising tungsten bronze wherein the particles have an average primary particle size of no more than about 250 nm.

21. The display device of claim 20 wherein the composite has a concentration of particles from about 1 weight percent to about 90 weight percent particles.

22. The display device of claim 20 wherein the composite has a concentration of particles from about 5 weight percent to about 85 weight percent particles.

23. The display device of claim 20 wherein the particles have an average primary particle size of no more than about 100 nm.

24. The display device of claim 20 wherein the composite further comprises electrically conductive particles selected from the group of elemental metal particles, metal alloy particles, electrically conductive carbon particles and mixtures thereof, wherein the electrically conductive particles have an average primary particle size of no more than about 100 nm.

25. The display device of claim 24 wherein the composite comprises from about 5 weight percent to about 85 weight percent inorganic oxide particles and from about 0.1 weight percent to about 12 weight percent supplemental electrically conductive particles.

26. The display device of claim 20 wherein the tungsten bronze has a composition with a formula MₓWO₃, where M is an alkali metal element.
